(19) United States
(12) Patent Application Publication
(10) Pub. No.: US 2014/0278985 A1
(43) Pub. Date: Sep. 18, 2014

(54) SYSTEMS AND METHODS FOR THE ENHANCEMENT OF SEMANTIC MODELS UTILIZING UNSTRUCTURED DATA

(71) Applicant: DataPop, Inc., Los Angeles, CA (US)

(72) Inventors: Cartic Ramakrishnan, Los Angeles, CA (US); Stephen John Zimmerman, JR., Los Angeles, CA (US); Jonathan Warden, Park City, UT (US); Behzad Zamanzadeh, Tarzana, CA (US)

(73) Assignee: DataPop, Inc., Los Angeles, CA (US)

(21) Appl. No.: 14/180,204

(22) Filed: Feb. 13, 2014

Related U.S. Application Data
(60) Provisional application No. 61/780,122, filed on Mar. 13, 2013.

(51) Int. Cl. G06Q 30/02

(52) U.S. Cl. CPC G06Q 30/0256
USPC 705/14.54

(57) ABSTRACT

Campaign creation systems and methods for enhancing semantic models using unstructured data in accordance with embodiments of the invention are disclosed. In one embodiment, a campaign creation server system a semantic model enhancement application configuring a processor to obtain unstructured data, parse the unstructured data into parsed data, where the parsed data includes at least one piece of token data including at least one word and at least one relationship, identify at least one token not present in a semantic model, when the token is determined to be a value, identify relevant attributes within the token based on the at least one relationship in the token, when the token is determined to be a category, identify at least one parent category in the semantic model based on the at least one relationship, and update the semantic model based on the identified at least one token.

### CROSS-REFERENCE TO RELATED APPLICATIONS

The current application claims priority to U.S. Provisional Patent Application Ser. No. 61/780,122, filed Mar. 13, 2013, the disclosure of which is hereby incorporated by reference in its entirety.

### FIELD OF THE INVENTION

The present invention relates to targeted search advertising and more specifically to the enhancement of semantic models used in the creation of targeted search advertising campaigns.

### BACKGROUND

The term e-commerce is used to refer to the buying and selling of products or services over electronic systems such as the Internet and other computer networks. The amount of trade conducted via e-commerce has grown extraordinarily with widespread Internet usage. As a result, varieties of websites have been established to offer goods and services. A common configuration for such a website is to present each individual good or service on a separate landing page. Such websites also typically organize the goods and/or services offered in a hierarchy and feature categories of goods and/or services on separate landing pages.

Search engines are useful tools for locating specific pages of information on the World Wide Web and are increasingly used to locate goods and services. As a result, many websites use search advertising/search engine marketing to attract visitors to product, service, and/or category landing pages. Search advertising describes the placement of online advertisements adjacent or amongst the search results returned by a search engine in response to a specific search query. Search engine marketing typically involves paying for a specific online advertisement or creative to be featured in or adjacent to the search results provided in response to a specific query. The creative typically includes a link to a specific landing page. In many instances, the provider of the search engine derives revenue when a user of the search engine uses the link within the creative to navigate to the landing page. In addition, the amount of money paid is often the result of a bidding process. Typically, the position of an advertisement within the returned search results is a function of the bid scaled by a quality factor that measures the relevance of the creative and landing page combination to the search query. Accordingly, the provider of the search engine is incentivized to feature relevant keyword/advertisement/landing page combinations so that users will select featured advertisements and increase the revenue generated by the search engine provider. In the context of paid search advertising, the term keyword refers to both a single word and a specific combination of words or keyword components.

When a website includes a large number of products or services, the process of building and managing a paid search advertising campaign can be quite complex. Many search engines provide the ability to upload an entire campaign including one or more creatives that target a set of keywords, and associated bids to be used when the display of the creative is triggered by specific keywords. For example, Google, Inc. of Mountain View, Calif., defines an Ad Group file format that enables advertisers to upload paid search advertising campaigns.

Leading search engine providers offer a variety of different match types when building a paid search advertising campaign. Keyword matching options or match types specify the similarity required between a keyword in a search query and a keyword specified in a paid search advertising campaign in order to trigger the display of a creative. Google, Inc. provides four different match types. “Broad match” matches keywords to similar phrases and relevant variations in a search query. “Modified Broad Match” is similar to “broad match,” but with the restriction that at least one specified keyword component or a close variant must match exactly within the search query. “Phrase match” requires that the keyword be present within the query exactly. “Exact match” requires that the keyword and the search query match exactly. In addition to the four match types, “negative matches” can also be specified to prevent a creative from being displayed when a specific keyword is present.

### SUMMARY OF THE INVENTION

Campaign creation systems and methods for enhancing semantic models using unstructured data in accordance with embodiments of the invention are disclosed. In one embodiment, a campaign creation server system includes a processor and a memory connected to the processor and configured to store a semantic model enhancement application, wherein the semantic model enhancement application configures the processor to obtain a semantic model, obtain unstructured data including at least one input sentence, parse the unstructured data into parsed data, where the parsed data includes at least one piece of token data including at least one word and at least one relationship, identify at least one token not present in the semantic model, when the token is determined to be a value, identify relevant attributes within the token based on the at least one relationship in the token, when the token is determined to be a category, identify at least one parent category in the semantic model based on the at least one relationship, and update the semantic model based on the identified at least one token.

### BRIEF DESCRIPTION OF THE DRAWINGS

FIG. 1 is a flow chart illustrating a process for building a targeted search advertising campaign using a semantic model in accordance with an embodiment of the invention.

FIG. 2 is a flow chart illustrating a process for mapping keyword components to attribute values within a semantic model in accordance with an embodiment of the invention.

FIG. 3 is a flow chart conceptually illustrating work flows associated with building and refining a semantic model using a combination of automated and human intelligence tasks in accordance with embodiments of the invention.

FIG. 4 is a flow chart illustrating a process for mapping keywords to concepts and identifying product and/or category landing pages to associate with the concepts in accordance with embodiments of the invention.

FIG. 5 illustrates a process for generating keyword, landing page, creative, and match type combinations for specific keywords within an adgroup in accordance with embodiments of the invention.

FIG. 6 is a conceptual illustration of a user interface illustrating creative templates that can be used to generate creatives for inclusion in an adgroup in accordance with an embodiment of the invention.

FIG. 7 is a flow diagram conceptually illustrating the creation of a targeted search campaign using adgroup templates and creative templates in accordance with embodiments of the invention.

FIG. 8 is an architecture diagram of a system for building a targeted search advertising campaign using a semantic model in accordance with an embodiment of the invention.

FIG. 9 is a flow diagram conceptually illustrating the creation of targeting data using inventory lists in accordance with an embodiment of the invention.

FIG. 10 is a flow diagram conceptually illustrating the creation of offer data using targeting data and inventory lists in accordance with an embodiment of the invention.

FIG. 11 is a conceptual diagram illustrating the relationships between a semantic model and semantic models of creatives, targets, consumer intents, offers, and products and services in accordance with an embodiment of the invention.

FIG. 12 is a flow diagram conceptually illustrating enhancing an existing semantic model using unstructured data in accordance with an embodiment of the invention.

FIG. 13 is a flow diagram conceptually illustrating parsing unstructured data to determine categories and attributes in accordance with an embodiment of the invention.

FIGS. 14A-14C are conceptual illustrations of parse trees in accordance with embodiments of the invention.

### DETAILED DESCRIPTION

Turning now to the drawings, campaign creation systems and methods for building semantic model based targeted search advertising campaigns in accordance with embodiments of the invention are illustrated. The term semantic model is used to describe a particular scheme for classifying products and/or services. Collectively products and/or services (indeed any object, person, idea, or action) can be referred to as a concept and, in many embodiments, concepts can be defined in terms of categories and attribute value pairs. In this way, a semantic model used to build targeted search advertising campaigns can also include elements of a taxonomy and/or an ontology in the sense that the possible attributes of classified concepts can also be specified as can the relationships (including hierarchical relationships) between those attributes. In several embodiments, a semantic model is constructed based upon keywords actually used by people searching for the specific products and/or services that are featured in an advertising campaign. In many embodiments, the semantic model is used to relate landing pages within a website or group of websites to categories and attributes. The semantic model can also be used to identify relationships between keyword components and the categories and attributes within the semantic model and these relationships used to identify potentially relevant keywords for use in targeting a search advertising campaign with respect to specific concepts defined by the categories and attributes within the semantic model. Effective or optimal creatives can then be automatically generated based upon the attributes of offers that are likely to perform well with respect to specific queries targeted by the search advertising campaign.

An offer can be considered to be the attributes of what is (e.g. the product) being offered or presented to the user by the targeted search campaign. An offer can include product and/or service related attributes and can include non-product/service related attributes, such as reviews. As is discussed further below, the set of attributes that define the offer can be utilized to identify landing pages relevant to a targeted search query and to generate one or more creatives to display in response to the targeted search query. In several embodiments, relevant landing pages are determined using the offer attributes based upon their precision and recall. In a number of embodiments, relevant queries can be targeted more effectively by defining targets using keyword, keyword match type and/or additional targeting criteria such as (but not limited to) the geographic location from which the search query originated, information collected by cookies in a browser application, and/or information within a user profile. In this way, an entire targeted search advertising campaign can be built specifying which creative/landing page combination to trigger in response to specific search queries.

In a number of embodiments, a set of products and/or services (i.e. concepts) advertised via one or more websites along with a list of keywords relevant to the products and/or services are processed to generate a semantic model. In a number of embodiments, the possible keywords include known keywords and keywords generated by combining keyword components from known keywords using known grammar patterns. The set of possible keywords is often referred to as the keyword space. In several embodiments, the semantic model maps the keywords in the keyword space to distinct concepts, and offer concepts can be identified within the semantic model that map to one or more creatives and one or more landing pages.

A semantic model generated in accordance with embodiments of the invention can be utilized to build a campaign. The campaign includes a set of adgroups. The adgroups provide search engine providers with information concerning the creative and landing page combination to display when a specific query occurs (i.e. in response to a specific target). Each adgroup typically includes a landing page, at least one creative, and at least one target. Although, any adgroup can be constructed appropriate to the requirements of a specific search engine provider in accordance with embodiments of the invention. A creative is the specific advertisement that is displayed as part of the search engine results and different creatives can be displayed with respect to the same landing page in response to different targeted search queries. Targets define the search queries targeted by the adgroup and can be defined in terms of any attribute of a search query including but not limited to keywords within the search query, keyword match type, and additional information that can derived from the search query such as the IP address from which the search query originated, cookies in the browser application used to provide the search query, and profile information associated with the user that submitted the search query. Once a campaign is deployed, the selection of creative and landing pages that are displayed in response to a keyword match can be refined to improve the performance of the overall campaign.

The semantic models used in the generation of a semantic advertising campaign can be improved utilizing unstructured data taken from a variety of sources related to products and/or offers targeted within the advertising campaign. Additional attributes and values for product data can be identified and incorporated into a taxonomy within the semantic models, improving the utility of the semantic models in generating additional targeted search advertising campaigns. In this way, unstructured data describing offers can be utilized to expand a taxonomy within a semantic model to enable more precise targeting of specific intents as identified by keywords to offers. In addition, the additional category and attribute information can be utilized to generate creative that are more relevant to the targeted intents.

The generation of targeted search advertising campaigns using semantic models and the enhancement of the semantic models using unstructured data describing offered within the targeted search advertising campaign in accordance with embodiments of the invention are discussed further below. Additionally, any of the various systems and processes described herein can be performed in alternative sequences and/or in parallel (on different computing devices) in order to achieve similar results in a manner that is more appropriate to the requirements of a specific application.

### Building Targeted Search Campaigns

A process for building a targeted search campaign using a semantic model in accordance with an embodiment of the invention is illustrated in FIG. 1. The process 10 can be performed by a campaign creation server system and includes fetching (12) data related to landing pages included in the website or websites that are being promoted by the campaign and data related to the manner in which people search for the products and/or services that are featured by the website or websites. In several embodiments, the landing pages can include category landing pages and specific product landing pages. In many embodiments, the fetched data includes a list of keywords. As discussed below, the keywords can be used to define a keyword space based upon the list of keywords and a set of keywords generated using the keyword components of the keywords in the fetched data and known grammar patterns. The fetched data is used to build (14) a semantic model that maps landing pages to categories and attribute values. The semantic model also maps keyword components to specific category and attribute values. Building (16) a campaign using the semantic model involves identifying concepts that can be targeted by the search advertising campaign based upon the categories and attributes within the semantic model. The semantic model can then be used to identify keywords from within the keyword space that are potentially relevant to the targeted concepts using grammar patterns and keyword components that are mapped to the category and attributes that form the basis of the concept. These potentially relevant keywords can be used to define targets for a search advertising campaign. The building of the campaign is completed by identifying the attributes of offers that are likely to perform well with respect to each of the targets (e.g. yield the highest click throughs, conversion, and/or revenue). The attributes of the offers can then be used to select landing pages and to generate creatives. As is discussed further below, the process of building a campaign in accordance with many embodiments of the invention can involve the automatic generation of creative, landing page, and target combinations. Once an offer is identified for each target and used to generate a landing page, creative, and target combination, the campaign can be deployed (18) to one or more search engine providers. In a number of embodiments, the performance of the campaign is monitored and the choice of landing page and creative for specific targets is modified in response to the performance of the campaign.

Although a specific process for building a paid search advertising campaign using a semantic model is illustrated in FIG. 1, any of a variety of processes can to build a semantic model and to generate a paid search advertising campaign using the semantic model can be utilized in accordance with embodiments of the invention. Although much of the discussion that follows refers to products and categories of products, targeted advertising campaigns in accordance with embodiments of the invention can be utilized to target advertising to concepts other than products including (but not limited to) concepts related to services. The creation of a semantic model, the use of the semantic model to build a campaign, the automatic generation of creatives, and the optimization of deployed campaigns in accordance with embodiments of the invention are discussed further below.

### Generating a Semantic Model

Construction of a targeted search advertising campaign for a number of landing pages in accordance with an embodiment of the invention involves building a semantic model that can be used to categorize all relevant keywords. In several embodiments, the semantic model is a lexicon or vocabulary of how people actually search for the specific products and services that are being featured by the advertising campaign. The semantic model maps keyword components to a specific category or attribute in the semantic model. In many embodiments, the semantic model includes categories arranged hierarchically (e.g. Furniture/Chairs/Wood) and one or more attributes defined using key/value pairs (e.g. Material: Birch). When the semantic model is organized as a hierarchy of categories with associated attributes, the semantic model can map keyword components to specific category names or attribute values. In other embodiments, a semantic model can be organized in any manner appropriate to a specific application. For example, the semantic model can include recursion support, triples, and/or more complex descriptive structures that can be used in place of (or in addition to) key/value pairs to define attributes.

### Semantic Model Relationships

In a variety of embodiments, semantic models are utilized to describe creative strategies, creatives, targets, consumer intent, offers, and product information. The semantic models allow for the relationships between the modeled data to be utilized in the creation of targeted advertising campaigns. A conceptual illustration of a variety of semantic models and the relationships between the models that can be utilized in accordance with a particular embodiment of the invention is shown in FIG. 11. The group of semantic models 1100 includes a creative strategy semantic data model 1110 including advertising strategy semantic models and a set of words associated with the creative strategy represented by the creative strategy semantic data model 1110. The creative strategy semantic data model is utilized to describe a creative strategy associated with the set of semantic model creatives 1120. The semantic model creatives 1120 are a semantic model of one or more creatives (including composite creatives including one or more creatives) that are part of the targeted advertising campaign. The semantic model creatives 1120 are utilized as target concepts targeted by one or more semantic model targets 1130. Semantic model targets 1130 are a semantic model of targets that are used to represent the target-related data such as, but not limited to, keywords, match types, and targeting criteria. Semantic consumer intent model 1140 is a semantic model representing consumer intent associated with one or more keywords and/or products. Consumer intent in a semantic model can be represented in a variety of ways, including, but not limited to, commercial intent, non-commercial intent, direct intent, implied intent, inferred intent, indirect intent, expressed intent, non-expressed intent. Consumer intent can be measured in many ways, including by measuring the search volume associated with the keywords and/or products associated with the consumer intent. Other techniques to measure and represent consumer intent in semantic consumer intent models 1140 can be used as appropriate to the requirements of a specific application in accordance with embodiments of the invention. Semantic model offer data 1150 describes offer data generated using semantic model targets 1130 and semantic model product data 1160 combined with the semantic model creatives 1120. The semantic model offer data 1150 semantically models the propositions made to the consumers as part of the targeted advertising campaign. Semantic model product data 1160 includes one or more products that are associated with a given semantic model target 1130; the semantic model product data 1160 is a semantic model of the products that are being advertised in the targeted advertising campaign.

Although a specific set of relationships between semantic models of data are described above with respect to FIG. 11, any variety of data and relationships can be utilized as appropriate to the requirements of a specific application in accordance with embodiments of the invention. Systems and methods for generating adgroups for use in a paid search advertising campaign in accordance with embodiments of the invention are discussed below.

Obtaining Categories and Attributes from Source Data

The process of building a semantic model in accordance with many embodiments of the invention involves obtaining a set of source data describing the products and categories of products featured on the website or group of websites that will be the subject of the campaign. In many embodiments, an initial crawl of the website or group of websites is performed. Typical crawls can include but are not limited to a product crawl, which pulls key pieces of information about each product, and a category crawl, which determines the categorization structure of the website or group of websites. In a number of embodiments, a filter crawl is also performed to obtain all relevant product filters on the site. In many embodiments, search results pages returned by the site in response to search queries based upon keywords of interest are also crawled and the search results pages used as landing pages within a targeted search campaign. In certain embodiments, the site categorization structure becomes the basis of category definitions within the semantic model. In effect, the source data provides information concerning the attributes of the products and/or services that can be presented to a user by the landing pages that are the subject of the advertising campaign. In addition to information about the products and/or services, the source data can also include information concerning search queries such as search logs, reports, keyword tools, and search query reports. In other embodiments, any of a variety of sources of data can be used to obtain information related to the attributes of products and/or services that will be presented in the paid search campaign. For example, a semantic reasoner or inference engine can be utilized to determine additional attributes associated with products and/or services. Accordingly, any of a variety of sources of data concerning the attributes of products and/or services can be utilized in the generation of a semantic model as appropriate to the requirements of a specific application in accordance with embodiments of the invention.

In many embodiments, the source data is processed to build a semantic model including a complete set of categories and attribute values that describe all of the products and/or services featured within the landing pages. In several embodiments, the semantic model is constructed in such a way that each landing page maps to a unique combination of category and attributes. As noted above, the category hierarchy can be generated automatically utilizing the scraped website(s) categorization structure and/or manually. The attribute values can also be added to the semantic model automatically and/or by hand. In several embodiments, specific products within the source data are not allocated a unique source data ID. Instead, a key attribute or combination of attributes or a hash of the key attribute or combination of attributes is used as a unique identifier, which can be referred to as the source data ID, to identify each product. In many embodiments, the key attribute is one or a combination of (or a hash of one or combination of) product ID, SKU (Stock Keeping Unit), and URL (Uniform Resource Locator). In the absence of such attributes, the key attributes can be a top-level category name combined with a subcategory name, or city name combined with a state code. In this way, the campaign can change as the landing pages change.

Although much of the discussion that follows refers to semantic models constructed using a combination of category names and attribute values, the category names can themselves be thought of as attribute values. Accordingly, the entire semantic model at an abstract level can be considered to use attribute values to categorize landing pages within a site or group of sites.

### Mapping Keyword Components to Attributes and Semantic Model Generation

The process of building a semantic model in accordance with embodiments of the invention also involves parsing relevant search keywords into keyword components that are the same as or are synonymous with category names or attribute values within the semantic model. As noted above, the term keyword in the context of targeted search advertising can refer to a single word or a combination of words. A keyword component refers to a single term within a keyword, such as “chair” or “bar stool”, that can be mapped to a single category name or attribute value within the semantic model. In many instances, multiple synonymous keyword components are mapped to the same category name or attribute value within the semantic model. Where the keyword component is neither the same nor a synonym of a category name or attribute value within the semantic model, a decision can be made concerning whether to discard the keyword component or to expand the semantic model to include the keyword component. In several embodiments, sources of keywords can include manual collection of keywords and/or the automated collection of keywords.

A process for mapping keyword components from relevant keywords to attribute values within a semantic model in accordance with an embodiment of the invention is illustrated in FIG. 2. The process 30 involves collecting (32) possibly relevant keywords and then classifying (34) the keywords according to their relevance. Relevant keywords can be obtained from a variety of sources including but not limited to search logs and keyword tools. In many embodiments, determining the relevance of keywords is a human intelligence task (i.e. a task performed by a human operator). Relevant keywords are parsed (36) to break them into components that match categories and attribute values within the semantic model. Parsing of keywords into keyword components is described below. In many embodiments, when the keyword component matches multiple categories or multiple attribute values within the semantic model, the keyword component can be mapped to each. In other embodiments, this ambiguity may be resolved with a human intelligence task (i.e. a task requiring the involvement of a human), or by using any number of algorithms that can resolve ambiguity. If a keyword component does not match the semantic model, then a determination is made concerning whether the keyword component is synonymous with an existing category name or attribute value or whether the keyword component represents an entirely new attribute value. There are a number of algorithms that can predict what category or attribute value a keyword component may be synonymous with, or that can resolve ambiguity. For example, a thesaurus can be utilized; in other embodiments, the similarity of the letters in the word to the letters in the category/attribute value or its synonyms can be utilized to resolve ambiguity. To resolve ambiguity, a data source such as Wikipedia disambiguation pages or using machine learning techniques using examples of other correctly-disambiguated keywords may be used. This determination can be automated or automated in combination with validation as a human intelligence task. When the keyword component represents a new attribute value, the semantic model is expanded (38) to accommodate the new keyword component. As discussed above, many semantic models utilize a hierarchy of categories and a number of different attributes can be used to describe a specific category. Therefore, expanding the semantic model can involve adding a new category, attribute, and/or attribute value to the semantic model. In this way, the semantic model can continue to expand with the goal of mapping all relevant keyword components to a category name or attribute value within the semantic model.

Although a specific process for mapping relevant keyword components to category names or attribute values is illustrated in FIG. 2, any of a variety of processes appropriate to specific applications can also be utilized in accordance with embodiments of the invention including processes that can be performed automatically and/or manually.

Parsing Keywords into Keyword Components

In many embodiments, parsing of keywords involves the use of a grammar-less parser, which utilizes the semantic model to parse the keywords into keyword components instead of a grammar. Components of the keywords map to category names and attribute values within the semantic model. Therefore, the semantic model can be used to identify grammatical rules. As is discussed further below, grammatical rules that are learned during the parsing of keywords can be used to predict “new” or previously unseen keywords in accordance with embodiments of the invention. These predicted keywords can be incorporated into a targeted search campaign so that the campaign is not limited to only those keywords included in the source data.

Although the use of grammar-less parsing is discussed above, a parser that utilizes a grammar and/or any of a variety of other parsers can be utilized in accordance with embodiments of the invention to parse keywords into keyword components.

Semantic Model Creation using Automation and Human Intelligence Tasks

The process of building a semantic model from source data, obtaining sources of relevant keywords, and then mapping each keyword or keyword component to a category name or attribute value within the semantic model can be complex. In many embodiments, the process is automated. In several embodiments, a hybrid approach to building a semantic model is utilized combining both automation and human intelligence tasks. A workflow for building a semantic model with the assistance of human decision makers is illustrated in FIG. 3. The workflow process 40 shown in FIG. 3 utilizes the Mechanical Turk marketplace provided by Amazon.com, Inc. of Seattle, Wash. for the performance of human intelligence tasks associated with the creation of the semantic model. It should be noted, however, that any form of human intelligence marketplace (or, indeed, any mechanical system simulating a human intelligence marketplace) that performs human intelligence tasks can be utilized as appropriate to specific applications in accordance with embodiments of the invention. The workflow process 40 includes three basic workflows: a keyword processing workflow 41, a human intelligence task workflow 42, and a semantic model improvement workflow 43.

The keyword processing workflow 41 is similar to the process illustrated in FIG. 2 (described above) and involves parsing (43) keyword components from keywords obtained from keyword sources (44) and identifying keyword components that are ambiguous or not already mapped to an attribute value within the semantic model. The handling of ambiguous or “new” keyword components can involve automated processes and/or human intelligence tasks.

In the illustrated embodiment, the human intelligence task workflow 42 involves providing the “turks” (i.e. the people performing the human intelligence tasks (45)) with templates in which the turks can enter attribute data for each product and/or service landing page, and for each category landing page. In addition to providing templates, instructions are typically also provided concerning the meaning of each attribute in the semantic model to increase the likelihood that attribute information is entered consistently. The turks then process (46) all of the source data concerning the products and/or services, which involves entering the different attribute values for the products and/or services featured in the landing pages into the templates. In many embodiments, the human intelligence tasks are performed by the turks on a small sample (47) and the semantic model, templates, and/or instructions are refined until a decision (48) to proceed is made the full dataset can be processed (46).

In the illustrated embodiment, both the keyword processing (41) and human intelligence task (42) workflows place attribute values or keyword components into a semantic model improvement queue. The determination of whether the keyword component or attribute value is relevant, a synonym of an existing category name or attribute value, a new value for an existing category or attribute, or an entirely new attribute or category can be a human intelligence task performed by an editor or by turks and/or involve an automated process. In several embodiments, new categories, attributes, and keyword components are placed in a semantic model improvement queue (49) and automated processes and/or human intelligence tasks are performed to determine whether an addition should be made to the semantic model. The workflows illustrated in FIG. 3 continue until all of the source data is processed and all of the keyword components and attribute values are cleared from the semantic model improvement queue or until a sufficiently high keyword space coverage is achieved. Keyword space coverage can be measured as the percentage of input keywords, in many embodiments weighted by search volume that can be mapped to a concept defined by the semantic model. Once a predetermined target keyword space coverage is achieved, the semantic model can be utilized to build a targeted search campaign in accordance with embodiments of the invention.

Although a specific process is illustrated in FIG. 3, any of a variety of fully automated, manual, or hybrid processes that map data from a set of source data to attribute values within a semantic model can be utilized into the building of a semantic model in accordance with embodiments of the invention.

### Building a Targeted Search Campaign Using a Semantic Model

The process of building a targeted search campaign in accordance with embodiments of the invention involves predicting relevant keywords and then using relevant keywords to identify targets for the advertising campaign using the semantic model. The identified targets are mapped to one or more relevant landing pages and creatives. Processes for identifying targets, generating creatives, and building targeted search campaigns using semantic models in accordance with embodiments of the invention are discussed further below.

Associating Keywords with Targets

A keyword space is a theoretical space containing all potentially relevant keywords identified in terms of a set of category and/or attribute values. Campaigns in accordance with many embodiments of the invention identify targets for the targeted search campaign based upon keywords in a keyword space. In many embodiments, identifying targets involves selecting a subset of keywords in the keyword space that are believed to be useful, relevant keywords. The process of selecting keywords can involve mapping known “good” keywords to concepts and/or generating/predicting relevant keywords using known keyword components and grammar patterns. In several embodiments, the process of identifying targets involves defining concepts representing unique combinations of categories and attribute values within the semantic model, and then using the combination of categories and attribute values to predict keywords relevant to the concept. In this way, relevant keywords can be predicted using the semantic model and targets identified by combining these relevant keywords with other relevant targeting criteria.

A process for identifying targets in accordance with an embodiment of the invention is illustrated in FIG. 4. When the landing pages have been semantically modeled (see discussion above), the process 50 builds (54) “concepts” for unique combinations of category names and attribute values from the semantic model. Concepts can generally be considered to reflect the meaning behind a specific search query. Once a set of concepts is defined using the semantic model, a set of keywords that maps to each of the concepts is determined (56). In many embodiments, attributes associated with the concept can be determined by targeting criteria or attributes other than the search query, such as the user's geographic location, age, or gender. For example, the concept [Men's Shoes], represented by the attributes CATEGORY=Shoes, GENDER=Male, may be linked to the keyword “shoes” combined with the Male targeting criteria. Once the concepts and associated relevant keywords are determined, one or more targets can be generated for each concept using the keywords in combination with other relevant targeting criteria. The process 50 can also involves generating (58) one or more targets for each concept.

A target is a specific search query or set of search queries that are to be targeted by a specific advertisement in the targeted search campaign and can include any of a variety of attributes derived from the query itself, IP addresses, browser cookies, and/or a user profile associated with the user that provided the query. The extent to which a search query can be targeted is not limited to the keywords utilized in the search query. Additional information can also be derived from a search query. For example, information concerning where a user is in the purchase funnel can be derived from language in the query indicative of intent (e.g. “customer reviews for KEYWORD” or “price of KEYWORD”). Accordingly, the same keyword can be targeted in different ways depending upon intent. In many instances, the campaign may choose to avoid targeting a keyword where it is unlikely to lead to the acceptance of an offer (e.g., “KEYWORD repair” is not related to the sale of the KEYWORD). Additional information can also be indirectly derived from a query such as geographic location. The IP address of the device from which a search query originates can be used to identify the geographic location of the IP address. Accordingly, keywords can be targeted in different ways in different geographic locations (e.g. “KEYWORD” in IP Address maps to Santa Monica, Calif. vs. “KEYWORD” in IP Address maps to Glendale, Calif.) Accordingly, targets in accordance with embodiments of the invention can include any of a variety of attributes that can be derived from a search query, including but not limited to attributes derived from the query itself, IP addresses, browser cookies, and/or a user profile associated with the user that provided the query. The mapping of keywords to concepts, and the generation of targets using the concepts are discussed further below.

### Generating Concepts Using Semantic Modeling

Concepts are a common way of representing semantic models and can be generated using unique combinations of category names and attribute values from a semantic model. For example, the category “Bar Stools” and the attribute key value “Material: Wood” form the concept “Wood Bar Stools”. A concept can be generated for every possible combination of category name and attribute value. In many embodiments, however, concepts are limited to a specified number of attributes. In several embodiments, intent can also be incorporated into the identified concepts. Such concepts can be referred to as intent concepts. The intent captured in the intent concept reflects the intention of users searching for the concept. As is discussed further below, intent concepts can be utilized to better target presentation of offers to users.

Many different concepts generated using category names and attribute values can have the same meaning. In a number of embodiments, concepts obtained by building unique combinations of category name and attribute values from the semantic model are regarded as “surface concepts.” Often surface concepts, although unique, refer to the same thing or are synonymous. For example, the surface concepts “ps4” and “Sony PlayStation 4 Video Game Console” actually refer to the same video game console. One surface concept includes MODEL and VERSION, whereas the other has BRAND, MODEL, VERSION, AND CATEGORY. The video game console to which both surface concepts refer can be considered a “deep concept.” A deep concept is a single canonical concept and typically includes all of the category name and attribute values that can be used to describe the concept. Stated another way, the deep concept holds all of the attributes of the concept and so describes the concept at its most granular.

When the distinction is made between surface and deep concepts, keywords are mapped to deep concepts as opposed to surface concepts. Use of deep concepts can simplify the construction of a campaign by combining all keywords with the same meaning into a single adgroup. In addition, deep concepts hold all of the information related to a concept and enable more complete mappings of surface concepts to offers. In many embodiments, the process of mapping deep concepts to surface concepts is relatively straightforward. The deep concept includes more attributes than the surface concept and the attributes of the surface concept map to a single deep concept. Where the attributes map to multiple deep concepts, then a disambiguation process can be used that can be a human intelligence task and/or include an automated process. Disambiguation processes that can be utilized to disambiguate the mapping of phrases to concepts in accordance with embodiments of the invention are discussed further below. The attributes of the deep concept can be useful in understanding how a surface concept relates to other concepts. For example, systems in accordance with embodiments of the invention can easily calculate that [CITY=Los Angeles, STATE=California] is subordinate to [STATE=California]. A concept is subordinate to another concept when the subordinate concept is included within or is a subset of the other concept. However, the system may not know that the surface concept [CITY=Los Angeles] is subordinate to [STATE=California]. However, if [CITY=Los Angeles] is first mapped to deep concept [CITY=Los Angeles, STATE=California], then the system can establish the relationship between the two surface concepts. Where attribute values are stored in a semantic model, systems in accordance with embodiments of the invention can use the semantic model to map surface concepts to deep concepts. A thesaurus can also be used to map surface concepts to a deep concept as can transformation rules that specify how a concept following a specific pattern (including but not limited to a grammar pattern) should map to a deep concept.

An inference engine may also be used to infer additional attributes from the attributes of the surface concept. In many embodiments, the set of all attributes inferred from the surface concept can be added to the attributes of the surface concept to obtain the deep concept. In this way, the deep concept can hold all of the attributes related to a concept. Once a set of deep concepts have been established, then the manner in which potentially relevant keywords map to the deep concepts can be determined in accordance with embodiments of the invention.

### Mapping Keywords to Concepts

In many embodiments, the set of keywords that map to a concept is generated using all possible combinations of the synonymous keyword components within the semantic model that are associated with the category names and attribute values that form the basis of the concept. For example, if the concept is “Wood Bar Stools” and the semantic model associates the synonymous keyword concepts “bar stools”, “barstool”, “barstools”, and “bar stool” with the “Bar Stools” category and the synonymous keyword concepts “wood”, and “wooden” for the “Wood” attribute then the keywords that map to the concept are “wood bar stools”, “wooden bar stools”, “wood barstool”, “wooden barstool”, “wood barstools”, “wooden barstools”, “wood bar stool”, and “wooden bar stool”. The combination of keyword concepts used in the above example can also yield the keywords “bar stools wood” etc., which are unlikely to be used in search queries. In many embodiments, therefore, the generation of a set of keywords that map to a concept also considers grammar patterns. Grammar patterns can be defined that specify the order in which category names and attribute values are combined. In many embodiments, the grammar patters include both a grammar component and a semantic component. Accordingly, the grammar patterns specify how specific keyword components can be used in specific contexts. In this way, combinations of grammar patterns are utilized to generate keywords. The combination of grammar patterns involves combining the semantic components of the grammar patterns in accordance with the associated keyword components. For example, in a video game semantic model grammar patterns can be derived such as ‘VIDEOGAME_RELEASE game’, ‘modern warfare CATEGORY’ and ‘video game’. These grammar patterns identify that the keyword component ‘game’ can be modified by VIDEOGAME_RELEASE, but can't necessarily stand alone as a keyword. The ‘video game’ keyword component, however, can stand alone as a keyword and the keyword component ‘modern warfare’ can modify CATEGORY. These grammar patterns can be utilized to produce keywords as follows: ‘VIDEOGAME_RELEASE game’+‘modern warfare CATEGORY’ produces ‘modern warfare game’, where ‘modern warfare’ is a value of the VIDEOGAME_RELEASE attribute and ‘game’ is a CATEGORY name. Keyword produced in this way are associated with their semantic components (VIDEOGAME_RELEASE and CATEGORY in the above example), and can thereby be distinguished from keywords that are identical but have different semantic components (ambiguous keywords or homographs). This allows ambiguous keywords or to be treated as different keywords.

In other embodiments, simpler grammar patterns that do not incorporate semantic content can be utilized that specify the ordering of roots and modifiers, and any static text that should go before, after, or in between attributes. A root is a keyword concept synonymous with a category name. A modifier is a keyword concept synonymous with an attribute value. In the example of the “Wood Bar Stools” concept described above, the specified grammar pattern is MATERIAL CATEGORY. In many embodiments, specific grammar patterns are associated with specific categories (e.g. MATERIAL CATEGORY: “Bar Stool”).

As is discussed below, the incorporation of semantic components into grammar patterns can significantly decrease the need to disambiguate keywords generated using the grammar patterns. The same keyword components and grammar patterns used to generate keywords associated with a particular concept can also be used to generate dynamic display names for use in creatives (see discussion below).

In many embodiments, the search volume and frequency of a grammar pattern and the keyword components combined using the grammar pattern can be used to help predict the likely search volume or frequency of keywords generated using the grammar pattern. The most frequent keywords can be those chosen for use in the targeted search campaign. When generating keywords, predicting search frequency based upon the search frequency of the keyword components and grammar patterns can be used to filter the generated keywords to predict the generated keywords that are most likely relevant to the targeted search campaign.

When mapping keywords to concepts, ambiguity can exist due to a single keyword mapping to multiple concepts. Incorporation of semantic components into grammar patterns can significantly reduce the need to perform disambiguation. In addition, use of machine learning to identify additional grammar patterns (including negative or incorrect grammar patterns) can further reduce the need for performing separate disambiguation processes. When ambiguity is present, a disambiguation process can be utilized to select the concept with which to associate a keyword. In many instances, probabilities can be assigned to each possible interpretation. In a number of embodiments, each possible interpretation is weighted based upon its estimated search volume. In many embodiments, the search volume estimate is based on the known search volume of the grammar patterns that make up the keyword, including the semantic components of those grammar patterns (such that two keywords with the same spelling but different semantic components—homographs—may have different scores). In several embodiments, disambiguation is a human intelligence task and/or involves automated processes. In many embodiments, blacklists are maintained to prevent specific ambiguous keywords from being associated with specific concepts.

Although specific processes for generating keywords using keyword components synonymous with the category name and attribute values included in a concept are discussed above, any manual or automatic process for mapping keywords to concepts that is appropriate to a specific application can be utilized in accordance with embodiments of the invention.

### Deriving Grammar Patterns

Grammar patterns can be derived from unparsed keywords with volume/value data that have unambiguous parsings. In addition, a machine learning system can derive additional grammar patterns and negative grammar patterns from a training data set including ambiguous parsings and the correct mappings for those keyword components and incorrect mappings for those keyword components. As the database of grammar patterns grows, the system is able to correctly parse more keywords from the known list of keywords. The system can then extract additional grammar patterns from these correct parsings, allowing it to correctly parse even more keywords. In this way, the ability of the system to correctly parse keywords and to generate relevant keywords using keyword components and grammar patterns associated with specific concepts can improve over time.

### Generating Targets

Target concepts are typically defined in terms of the commercial intent of a search query or an intent concept. A target may include a keyword in addition to any targeting criteria associated with a search query. A simple target can be a keyword that has been generated for a target concept or more specifically a deep concept. More complex targets can include search query attributes indicative of a consumer's geographic location, age, gender, or other characteristics that may be of interest to a marketer and/or connected to the target concept or consumer intent. In many embodiments, additional attributes of a search query can be targeted including but not limited to information derived from a user's IP address, a cookie within the browser application used to submit a query, and/or a user profile. In many embodiments, these additional attributes may be selected using an inference engine that selects those attributes of a search query that are likely to be present for consumers with intent indicated in the given intent concept. For example, a target concept may include attributes CATEGORY=Shoes and GENDER=Male. A target may be generated for the target concept that includes all search queries for the keyword “shoes” made by men or it may include all search queries for the keyword “men's shoes.” The extent to which additional attributes are included in the selection of targets is often determined based upon the requirements of a specific application.

### Targeting Offer Concepts

An offer concept defines the attributes of an offer that is presented to a user in response to a targeted search query. As is discussed further below, the attributes of an offer concept are not necessarily the same as the attributes of the concept used to generate a target (i.e. the target concept). Whereas a target concept describes what a user is searching for, an offer concept describes what the website(s) that are the focus of the paid search advertising campaign can offer the user. In many embodiments, a campaign creation system attempts to match the offers (i.e. the offer concepts) that are likely to yield the best outcome (e.g. click throughs, conversions, revenue) with respect to a specific target. Once an offer concept is matched to a target, the attributes of the targeted offer concept can be utilized to select a landing page and to generate creatives that can be used to present the offer to a user in response to a targeted search query.

A target concept does not necessarily correspond to an offer concept (i.e. a set of attributes presented in an advertisement). The offer concept is expressed as a combination of actual offer attributes (e.g. “LCD TVs”). Although the target concept is often also just a combination of attributes, it might contain attributes that are not an actual part of the offer. For example, (e.g. “Comparison LCD and Plasma TVs”). In many instances, the advertiser's landing pages may not include a “comparison.” The advertiser offers TVs, or LCD TVs, or Plasma TVs and the target concept is mapped to one of these offer concepts. In general, once a target concept has been unambiguously mapped to a deep concept, it is mapped to an offer concept as part of the process of determining relevant ads and landing pages. There could be various rules for making this mapping, such as choosing one of the 2 concepts being compared as the offer concept, or choosing the most common ancestor (e.g. televisions).

Another example of target to offer concept mapping is mapping the concept:

“Dentists Near Santa Monica,” which is defined using the attributes OFFER_TYPE=Small Business/Dentists and NEAR_LOCATION=California/Los Angeles/Santa Monica

to the offer concept
“Dentists in Venice Beach,” which is defined using the attributes OFFER_TYPE=Small Business/Dentists NEAR_LOCATION=California/Los Angeles/Venice Beach)

Such a mapping can make use of a “fact base” containing information such as the fact that Venice Beach is near Santa Monica. Although specific processes are outlined above for determining relevant landing pages for specific targets including processes that involve mapping target concepts to offer concepts, any of a variety of processes can be utilized to identify one or more relevant landing pages for a specific target in accordance with embodiments of the invention.

In many embodiments, one or more offer concepts are mapped to a target concept based upon the target concept and offer concept combination that is likely to maximize or improve a predetermined metric such as (but not limited to) click throughs, conversions, and/or revenue. In a number of embodiments, a machine learning process is used to map offer concepts to the intent concepts underlying a specific target. Appropriate machine learning processes include (but are not limited to) a process based upon a Gaussian Art Map, Group Lasso, decision trees, and any other appropriate machine learning technique that can utilize semantic metadata or features (i.e. semantic information describing a concept within the semantic model) to estimate performance of mapping a specific target to a specific offer concept. In several embodiments, a campaign creation server system used to build and deploy a campaign tracks metrics concerning the performance of the campaign including (but limited to) total impressions, click throughs, conversion and revenue for each intent concept and offer concept combination. This information can be utilized to generate reports and analytics concerning that attributes that have the most influence on the performance of different intent attributes. The aggregated performance data is also used in the manner described above to select specific intent concept and offer concept combinations that will improve the performance of the overall campaign.

In several embodiments, offer concepts that are matched to a target are constrained to offer concepts corresponding to products that are part of the advertiser's inventory of products and services. In many embodiments, this inventory is the set of products and/or services represented on the landing pages in the advertiser's web site. In many embodiments, this inventory is determined from additional source data obtained about the advertiser's products and services, for example from the advertiser's product catalog. In several embodiments, this inventory may additionally be determined from the content of the creative and keywords in the advertisers existing search advertising campaign. In many embodiments, offer concepts are selected based upon custom rules selected by the marketer conducting the targeted search advertising campaign. For example, a marketer might direct a campaign creation server system to offer the top selling product when the customer has brand intent, which translates to selecting the best intent concept/offer concept combination where the intent concept includes the BRAND attribute and the offer concept includes the PRODUCT attribute.

### Target Generation Using Inventory Lists

In a variety of embodiments, a targeted search campaign is designed to advertise a particular set of products. Given an inventory list of products, a set of targets can be generated based on the set of products and utilized to create offer concepts included in a targeted search campaign. A process for generating targeting data for a set of products in accordance with an embodiment of the invention is illustrated in FIG. 9. The process 900 includes obtaining (910) an inventory list. Feature lists are identified (912) and targets are generated (914).

In a variety of embodiments, an inventory list containing a set of product information is obtained (910) from an advertiser; however, inventory lists can be obtained (910) from any source as appropriate to the requirements of specific applications in accordance with embodiments of the invention. In several embodiments, an inventory list contains a set of attributes and one or more sets of values associated with each of the attributes. In a number of embodiments, identifying (912) feature lists includes matching a first value (or multiple values) associated with a first attribute with one or more related values associated with a second attribute (or attributes). Generating (914) targets includes grouping one or more sets of attribute/value pairs for one or more of the products identified in the inventory list. In many embodiments, the sets of attribute/value pairs for one or more of the products include at least one of the identified (912) feature lists. In a variety of embodiments, the granularity of generated (914) targets can be controlled by adjusting the identified (912) feature lists associated with the generated (914) target. In several embodiments, the granularity of a target is determined based on the cardinality of the set of attribute/value pairs associated with the target, where the smaller the cardinality, the more granular the generated (914) target. However, any technique for determining the granularity of the target can be utilized as appropriate to the requirements of specific applications in accordance with embodiments of the invention. In a number of embodiments, one or more match types are associated with one or more of the generated (914) targets.

By way of example, a sample inventory list can include the set of attributes {Category, Color, Size} and the sets of values {Pants/Jeans, Blue, 34}, {Pants/Jeans, Black, 36}, and {Pants/Trousers, Blue, 32}. Example identified (912) feature lists include ‘Jeans: Color={Blue, Black}’ and ‘Pants: Size={32, 34, 36}’, where the feature lists have associated attributes with values from other attributes. Example generated (914) targets include the sets of attribute/value pairs {Blue Jeans}, {34 Pants}, and {Blue 32 Trousers}. Any variety of sets of attributes and values not specifically described above can be utilized as appropriate to the requirements of specific applications in accordance with embodiments of the invention.

A specific process for generating a set of targets based on an inventory list is described above with respect to FIG. 9; however, any number of processes can be utilized to generate a set of targets as appropriate to the requirements of specific applications in accordance with embodiments of the invention. Methods for generating offers and generating targeted advertising campaigns are described below.

### Offer Generation Using Targets and Inventory Lists

Given a set of targets and the inventory list associated with the targets, a variety of offers can be generated. These offers identify one or more features of the targets that can be utilized to create targeted advertisements. In a variety of embodiments, the advertisements are targeted toward search queries having an intent associated with the identified features of the offers. A process for generating offers in accordance with an embodiment of the invention is illustrated in FIG. 10. The process 1000 includes obtaining (1010) an inventory list and obtaining (1012) a set of targets. Target product sets are determined (1014). Feature value data is generated (1016). Offer data is generated (1018).

In many embodiments, obtaining (1012) an inventory list and/or obtaining (1012) a set of targets are performed utilizing processes similar to those described above. In a number of embodiments, determining (1014) target product sets includes identifying one or more products in the inventory list, where the identified products have attribute/value pairs matching the attribute/value pairs for a target in the set of targets. Target product sets (1014) are determined for one or more targets in the set of targets. In several embodiments, generating (1016) feature value data includes identifying the unique values in the determined (1014) product sets and associating an offer characteristic with each of the values. Offer characteristics can be pre-determined and/or determined dynamically based on the attributes and values identified. Pre-determined offer characteristics include lowest <attribute>, most popular <attribute>, largest <attribute>, and least popular <attribute>, although any offer characteristics can be utilized as appropriate to the requirements of specific applications in accordance with embodiments of the invention. Offer characteristics can be global (that is, utilized across a variety of sets of targets and inventory lists) or entity-specific (that is, the offer characteristics are associated with a particular merchant, retailer, and/or advertiser). In a variety of embodiments, generating (1018) offer data includes associating a portion of the generated (1016) feature value data with at least one of the determined (1014) target product sets for at least one of the targets in the obtained (1012) set of targets.

Although a specific process for generating offers based on a set of targets and an inventory list is described above with respect to FIG. 10, any variety of processes for generating offers can be utilized as appropriate to the requirements of specific applications in accordance with embodiments of the invention. Systems and methods for generating offers and generating targeted advertising campaigns are described below.

### Mapping Targeted Offer Concepts to Landing Pages

The creation of a targeted search campaign involves specifying targets, identifying one or more offers that are relevant to the targets (i.e. the targeted offer concepts) and generating creatives and selecting landing pages based upon the attributes of the offers. For each offer, there may be multiple relevant landing pages and a mapping between targets and landing pages can be made using the attributes of the offer concept targeted by a specific target. In a number of embodiments, the landing pages that are mapped to a specific target are determined based upon precision and recall with respect to the targeted offer concept. The precision of a landing page can be determined based upon the number of products represented on the landing page that are subordinate to the targeted offer concept as a percentage of the total number of products represented on the landing page. The recall of a landing page with respect to a targeted offer concept is the number of products represented on the landing page that are subordinate to the targeted offer concept as a percentage of the total number of products in the advertiser's inventory (i.e. products that appear on any landing page) that are subordinate to the offer. Based upon the precision and recall of specific landing pages to a targeted offer concept, a match can be determined. In many embodiments, the landing page matched to a specific target can be determined based upon a target concept (i.e. the concept indicating the intent of the search query). In several embodiments, a featured offer page can also be selected where present. In many embodiments, page scoring can be performed based upon customer rating and/or price with the product landing page with the highest customer rating selected and the highest price offer acting as a tie breaker between product landing pages featuring similar customer ratings. As is discussed further below, a number of landing pages can be utilized when building creatives based on a targeted offer concept and the system can test each of the landing pages and determine which is the most effective for specific targets. If there is no closely or matching landing page, then the concept can be ignored or placed in a low-quality group.

### Generation of Dynamic Display Names

Dynamic display names can be generated for each targeted offer concept and the dynamic display names can be utilized in the generation of creatives that are displayed in response to a query matching the relevant target. In a number of embodiments, the generation of dynamic display names is similar to the process described above for generating a set of keywords for a specific concept. The difference, however, is that instead of generating a set of keywords the process is used to generate a single phrase. In a number of embodiments, the phrase is selected to be the shortest or most common form of the phrase. In several embodiments, the grammar pattern and keyword concept components that have either the highest search volume or the most impression or that have appeared in creatives that received the most clicks or conversions are used as the basis to generate the dynamic display name for an offer concept. In a variety of embodiments, the dynamic display names are generated based on spacing requirements and/or length requirements, where the spacing requirements and/or length requirements apply constraints to the number of letters or words that can appear in the dynamic display name and/or to the space necessary to display the dynamic display name. In many embodiments, the grammar patterns and/or keyword concept components are grammar-corrected before being used to generate the dynamic display name. In other embodiments, any of a variety of techniques appropriate to a specific application can be utilized to generate a dynamic display name, including those that generate alternative display names based on the generated display name, in particular alternative display names that are grammatically correct and conform to length limitations and/or spacing limitations, in accordance with embodiments of the invention.

### Campaign Building

When keywords have been mapped to concepts, concepts have been used to generate targets, one or more relevant offer concepts have been identified for each target concept, and one or more relevant landing pages have been identified for each offer concept, using a process similar to the processes outlined above, a targeted search advertising campaign in accordance with embodiments of the invention can be built. The process of building the campaign involves creating adgroups, which are lists of keywords and creatives with associated settings, such as but not limited to the match type, IP target, or other targeting attributes of the ad group. These adgroups then form the basis of a targeted search campaign that can be uploaded to a search engine provider. The search engine provider uses the adgroups to define the creatives to display when a search query is received that matches one of the keywords within the adgroup in accordance with the match type specified in the adgroup. Processes for building adgroups in accordance with embodiments of the invention are discussed further below.

### Building Adgroups

In many embodiments, an adgroup is generated for each target concept. As noted above, an offer concept is typically matched to each target concept to translate the intent of the query into an offer that can be presented by the website(s) that is the focus of the targeted search advertising campaign. Creatives can be generated using the attributes of the targeted offer concept and one or more relevant landing pages having different degrees of specificity can be identified using the targeted offer concept. In many embodiments, a separate adgroup is generated for each landing page that is associated with each target concept (one ad group per target concept/landing page combination). The targets included in each adgroup are derived from the keywords associated with the target concept that is the basis of the adgroup. For each ad group, at least one creative and landing page combination is defined along with the match type of the keyword. As is discussed further below, more than one creative and landing page combination may be defined for each keyword to accommodate targeting of the advertising based upon such characteristics as geographic location. In a number of embodiments, a set of creatives is created using the attributes of the targeted offer concept and the performance of the different creatives with respect to each target is tested and used to refine the selection of the specific creative to display with respect to a specific target. In many embodiments, however, the traffic for a number of the keywords is too low to extract meaningful data concerning the performance of different creatives. Therefore, the creatives that are displayed in relation to specific keywords is defined during the building of the campaign and modified based upon analysis of the performance of the campaign. When adgroups have been generated with respect to all of the target concepts within the semantic model, the adgroups can be converted into bulk sheets that can be uploaded to one or more search engine providers to commence the targeted search campaign.

### Building Adgroups Using Templates

Adgroups and creatives can be constructed using templates. A process for generating an adgroup using adgroup and creative templates in accordance with an embodiment of the invention is illustrated in FIG. 5. The process 70 commences by selecting (72) an adgroup template for the adgroup. In several embodiments, the adgroup template is determined based upon the type of landing page. For example, a different adgroup template can be used depending upon whether the adgroup links to a product landing page or a category landing page. The difference in the adgroup templates may be as minor as specifying different URLs to display. In many embodiments, the adgroup template is selected based on the offer concept and the attributes present in the offer concept. However, different adgroup templates typically include different creative templates. Once an adgroup template has been selected, creative templates are selected (74) and used to generate creatives based upon the attributes of a targeted offer concept. A set of creative templates is defined for each ad group template. In several embodiments, the first creative template that fits (i.e. satisfies formatting requirements for the creative imposed by search engine providers) is selected and used to generate (76) a creative using the attributes of a targeted offer concept.

A user interface used to edit creative templates in accordance with embodiments of the invention is illustrated in FIG. 6. In the illustrated embodiment, the user interface 80 indicates that a single adgroup template exists (i.e. irrespective of the inputs in the adgroup template, the same creative templates are utilized to generate creatives) and a list of creative templates are provided based upon the attribute values present in the offer concept. If the “Book Name” attribute value is present in the offer concept, then the first creative template that fits the formatting requirements of the search engine provider is selected. Otherwise, creative templates defined for other attribute values are tested. In the illustrated embodiment, the creative is generated by inserting the relevant attribute values associated with the offer concept that forms the basis of the adgroup into the template. The first creative template 82 includes the static text “at Target” in the title of the creative. If the number of characters of the title is too long after substituting the PRODUCT_TITLE attribute of the offer concept into the creative, then the second creative template 84 does not include the “at Target” static text to reduce the length of the title. In many embodiments, the creative template may include a placeholder for the display form of the offer concept described above. In many embodiments, the creative template may be generated automatically by the system from examples of human-written creatives associated with offers, by replacing attributes of the offer found in the creative with a placeholder for the attribute name. For example, if a creative associated with an offer containing attributes CATEGORY=Televisions and SCREEN_TYPE=LCD contains the text “Deals on LCD TVs”, then this text can be converted to the template “Deals on {SCREEN_TYPE} {CATEGORY}”. Using templates in the manner outlined above, a creative can be generated for each adgroup. A process 700 for generating adgroups and uploading a bulk sheet to the Google search engine provided by Google, Inc. is illustrated in FIG. 7. Although the use of adgroup templates and creative templates is described above with respect to the generation of creatives for a specific adgroup, in many embodiments other techniques appropriate to specific applications can be used to generate creatives for inclusion in adgroups in accordance with embodiments of the invention. In particular, any of a variety of techniques can be utilized to provide the details of a targeted search advertising campaign to a search engine provider in accordance with embodiments of the invention.

### Generation of Creatives Using Advertising Strategies

Another approach for generating creatives for inclusion in adgroups in accordance with embodiments of the invention is to define “strategies” for selecting creative templates. A strategy associates a target with a specific landing page and a specific set of creative templates. For example, a strategy could associate any targets within a geographic area searching for reviews of televisions with a featured offer landing page for the highest rated television, and a creative theme that shows a rating. Because the strategy associates both a landing page and a creative with a specific target, both the landing page and the creative can be optimized over time to improve the performance of the strategy.

### Selection of Adgroup Match Type

The selection of a broad match type for an ad group can result in the keywords submitted to the search engine operator, sometimes referred to as the bidded keywords, matching many different actual user queries. As a result, specific search queries may “match” different bidded keywords, in which case the creative and landing page combination that is displayed within the search results is left to the search engine provider to decide.

When the set of user queries matched by two different targets overlap, then it can be said that one target is “stealing” traffic from another. In conventional search advertising campaigns, targets can steal a significant volume of traffic from each other unless very restrictive match types are used. The segment of traffic that is captured by a specific target can be defined as all user queries that match the target less the user queries that are stolen by overlapping targets. When viewed in this way, the segment of traffic matched by a target is determined not only by the target itself, but other targets that are currently active in the ad campaign.

Understanding the segment of traffic captured by a target is further complicated by the fact that bids and quality scores for different creative/landing page combinations change over time. Therefore, when optimizing an advertising campaign, smaller changes are typically performed so that the changes do not significantly alter the traffic segments for the targets. In many embodiments, the goal of the optimization is to filter targets that are not driving traffic to the website or group of websites targeted by the campaign or that are driving traffic that is unlikely to accept the presented offer and to modify the selection of creative and landing pages to improve the performance of the campaign (i.e. acceptance of offers) with respect to the targets that are effective in driving traffic to landing pages. In a variety of embodiments, the goal of the optimization is to filter keywords that map to the same concept. The optimization process can be complicated by the statistically small number of samples that may exist with respect to specific targets. Therefore, the optimization processes can be improved by grouping samples for targets based upon common attributes of targets, such as (but not limited to) targets that include the same brand, product type, IP location, or any combination of these attributes. Multivariate testing can then be applied to help make decisions concerning targets to try as the campaign progresses. In addition, the most effective targets, and the most effective advertisement/landing page combination for each target are likely to change over time. Therefore, continued modification of the campaign can be important to sustaining the performance of a campaign.

### Keyword Discovery Using Controlled Expansion of Match Types

When a match type for a particular keyword is broadened, the keywords that are determined to match a target within a paid search campaign can include previously unknown keywords. In a number of embodiments, keywords that are “discovered” in this way can be used to improve the semantic model and the performance of the overall campaign. In many embodiments, the match type of a specific keyword is broadened and a number of new keywords are discovered. These keywords can be used to refine the semantic model. New creative and landing page combinations can be defined for targets that include the newly discovered keywords and narrower match types can be utilized for the original target and the new targets to further refine the performance of the campaign.

### Campaign Optimization

In a number of embodiments, a campaign built using processes similar to those described above is deployed in combination with an existing campaign. In many instances, a marketer with domain expertise will have highly optimized certain keyword, creative, and landing page combinations. By deploying a hybrid campaign, these highly optimized keywords, creatives, and landing page assignments can be incorporated into a targeted search advertising campaign generated using a semantic model. Over time, the performance of the overall campaign can then be improved using any of a number of optimization techniques including but not limited to multivariate testing to determine alternative creatives and/or landing pages to try with the non-optimized keywords.

### Enhancing Semantic Models Using Unstructured Data

As described above, semantic models can be utilized in the generation of targeted search advertising campaigns. By enhancing the semantic models based on unstructured data taken from a variety of sources related to products and/or offers, additional attributes and values for product data can be incorporated into the semantic models, improving the utility of the semantic models in generating additional targeted search advertising campaigns. A process for enhancing a semantic model using unstructured data in accordance with an embodiment of the invention is illustrated in FIG. 12. The process 1200 includes obtaining (1210) a semantic model. Unstructured data is obtained (1212) and parsed (1214). If a new value is discovered (1216) within the unstructured data, relevant attributes in the semantic model are identified (1218). If a new category is discovered (1220), a relevant parent category is identified (1222). The semantic model is updated (1224).

In a variety of embodiments, a semantic model is obtained (1210) utilizing processes similar to those described above. Unstructured data can be obtained (1212) from a variety of sources, including, but not limited to, creative text (e.g. text associated with one or more advertisements) and product descriptions (e.g. web pages describing products from a retailer and/or manufacturer), although any unstructured data with linguistic structure can be utilized. Parsing (1214) the unstructured data includes generating a parse tree using a dependency parser or other linguistic parser as appropriate to the requirements of a specific application in accordance with embodiments of the invention. In a variety of embodiments, a parse tree includes one or more tokens having one or more words along with relationship information between the words within the token. In several embodiments, the parse tree includes relationship information between the tokens. The parsed (1214) data can be analyzed utilizing a variety of processes, including those described below, to identify categories and/or attribute-value pairs within the parsed data. If a new value is discovered (1216) along with a known attribute, the attribute is identified (1218) within the semantic model based on words associated with the discovered (1216) new value and the semantic model is updated (1224) to associate the newly discovered (1216) value with the attribute within the semantic model. For example, if the parsed data includes the terms “white gold watch,” the term ‘watch’ can be identified as a category with the attribute ‘WATCH_TYPE’ within the semantic model and the semantic model is updated to include the value ‘white gold’ associated with the attributed ‘WATCH_TYPE’

If a new category is discovered (1220) in the parsed data, the parsed (1214) data can be utilized to identify (1222) a related category within the semantic model. The new category (1220) can be included in the updated (1224) semantic model by adding the new category and a relationship between the new category and the identified (1222) category within the semantic model. For example, if the parsed data includes the term ‘Omega Speedmaster watch,’ the semantic model may include the categories ‘Rolex Datejust’ and ‘Omega Seamaster’ that are related to the category ‘WATCHES’ and the semantic model can be updated by adding the category ‘Omega Speedmaster’ to the semantic model along with a relationship between the category ‘WATCHES’ and the category ‘Omega Speedmaster.’ In this way, unstructured data describing offers can be utilized to expand a taxonomy within a semantic model to enable more precise targeting of specific intents as identified by keywords to offers. In addition, the additional category and attribute information can be utilized to generate creative that are more relevant to the targeted intents.

Additionally, the following are examples of identifying (1218) new values for known attributes and identifying (1220) a new category with respect to a semantic model in accordance with embodiments of the invention. For example, the following input sentence taken from an ad creative: “Buy a Coach Tour Dress in Blue with stylish touches such as a ascot-style collar.” The input sentence is run through a dependency parser that produces a parse tree conceptually illustrated in FIG. 14A.

If the seed semantic model (e.g. an existing semantic model) contains an attribute COLLAR_TYPE, a rule semantic interpretation module can detect the fact that the word ‘collar’ maps to the attribute COLLAR_TYPE within the semantic model. However if the word ‘ascot-style’ is not in the list of allowable values of the attribute COLLAR_TYPE then the semantic interpretation module will not recognize ‘ascot-style’ as an instance of COLLAR_TYPE. Additionally, the semantic interpretation module can identify the most frequent adjectival modifiers (amod) that are attached to a known attribute such as COLLAR_TYPE.

Additionally, new categories to be added to the semantic model based on a variety of input sentences. For the following input sentences, the parse trees conceptually illustrated in FIG. 14B and FIG. 14C can be generated in a variety of embodiments of the invention.

The input seed semantic model may contain ‘Coach Tour Dress’ as a category under ‘Tour Dress’ but may not contain the category ‘Scenic Tour Dress’. In such a situation the parse tree can be used as a mechanism to induce tree patterns that define the context in which ‘Tour Dress’ occurs most frequently. Using these induced patterns, new variants of the category ‘Tour Dress’ duly modified by modifiers such as ‘Scenic’ can be harvested from the input sentences. These variants can be reviewed and curated to determine which of the suggested variants are to be added to the seed semantic model.

Although a specific process for enhancing a semantic model using unstructured data is described above with respect to FIG. 12, any of a variety of processes can be utilized in accordance with embodiments of the invention. In particular, the modules described above can be implemented in software that configures a processor to perform the functions described above. Methods for determining categories and attributes within unstructured data are described below.

Determining Categories and Values within Unstructured Data

Unstructured data, by definition, lacks any predetermined structure giving meaning to the words that appear within the unstructured data. By parsing the unstructured data and identifying tokens within the parsed data, categories and values can be determined for use in enhancing semantic models. A process for determining categories and attributes within unstructured data in accordance with an embodiment of the invention is illustrated in FIG. 13. The process 1300 includes obtaining (1310) unstructured data. The unstructured data is parsed (1312) and patterns are identified (1314). Tokens are identified (1316) and labeled (1318).

In a number of embodiments, obtaining (1310) unstructured data and parsing (1312) the unstructured data is performed utilizing processes similar to those described above. In several embodiments, patterns are identified (1314) within the parsed data based on comparing words within the parsed data against known attribute types and values. The known attribute types and values can be taken from the existing semantic model, although a variety of embodiments utilize global pattern data or training semantic models instead of or in addition to the existing semantic model. Other techniques can be utilized to identify (1314) patterns within the parsed data as appropriate to the requirements of a specific application in accordance with embodiments of the invention. Using the identified (1314) patterns, tokens representing possibly unknown (in the sense that the tokens do not appear within the existing semantic model) data are identified (1316). In many embodiments the identified (1316) tokens are linguistically coupled to the identified (1314) patterns within the unstructured data. In a number of embodiments, the identified (1316) tokens are associated with the identified (1314) patterns within the parsed (1312) data. In several embodiments, the tokens are labeled (1318) using an external data source providing a labeling source for tokens (and/or other text data), such as the Wikipedia service from the Wikimedia foundation or the WordNet service from Princeton University. In a variety of embodiments, the tokens are labeled (1318) using a probabilistic model (such as, but not limited to, Conditional Random Fields) and/or machine learning models (such as a Bayesian inference engine or a neural network) that are configured to apply labels to data. The labeling process can be hand-tuned and/or hand-verified in order to provide training to the models in order to improve future performance of the labeling (1318) process. A number of labels, including categories, attributes, and values, can be applied to the tokens as appropriate to the type of data represented by the identified token. Other labels can be applied to tokens as appropriate to the requirements of a specific application in accordance with embodiments of the invention.

Although a specific process for parsing unstructured data in accordance with an embodiment of the invention is described above with respect to FIG. 13, any of a variety of processes, including those that identify pieces of data that are not categories or values, can be utilized in accordance with embodiments of the invention. Systems and methods for generating targeted search advertising campaigns are described below.

### System Architecture

As can be readily appreciated, any of a variety of architectures can be used to implement a system for building a targeted search campaign using a semantic model in accordance with embodiments of the invention. In many embodiments, a campaign creation server system is provided that includes one or more servers having processors configured via software (such as, but not limited to, campaign creation applications and semantic model enhancement applications) to perform processes similar to those outlined above. In several embodiments, the campaign creation server system also includes databases and/or warehouses to store source data, semantic models generated using source data, and campaigns built using the semantic model. A specific architecture constituting a campaign creation server system 800 in accordance with an embodiment of the invention is illustrated in FIG. 8. Although a specific architecture is illustrated in FIG. 8, any of a variety of alternative architectures appropriate to a specific application can also be utilized in accordance with embodiments of the invention including locally and remotely hosted campaign creation systems and systems that integrated with a search engine paid search advertising system.

Although the present invention has been described in certain specific aspects, many additional modifications and variations would be apparent to those skilled in the art. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A campaign creation server system, comprising:
a processor; and
a memory connected to the processor and configured to store a semantic model enhancement application;
wherein the semantic model enhancement application configures the processor to:
obtain a semantic model;
obtain unstructured data comprising at least one input sentence;
parse the unstructured data into parsed data, where the parsed data comprises at least one piece of token data comprising at least one word and at least one relationship;
identify at least one token not present in the semantic model;
when the token is determined to be a value, identify relevant attributes within the token based on the at least one relationship in the token;
when the token is determined to be a category, identify at least one parent category in the semantic model based on the at least one relationship; and
update the semantic model based on the identified at least one token.
